(19) United States
(12) Patent Application Publication
(10) Pub. No.: US 2020/0160523 A1
(43) Pub. Date: May 21, 2020

(54) System and method for assessment of cell viability

(71) Applicant: ContinUse Biometrics Ltd., Tel Aviv (IL)

(72) Inventors: Zeev ZALEVSKY, Rosh HaAyin (IL); Ran CALIFA, Givataym (IL); Sagi POLANI, Tel-Aviv (IL)

(21) Appl. No.: 16/573,220

(22) Filed: Sep. 17, 2019

Related U.S. Application Data
(60) Provisional application No. 62/733,795, filed on Sep. 20, 2018.

(51) Int. Cl. G06T 7/00

(52) U.S. Cl. CPC G06T 7/0016; G06T 2207/30024; G06T 2207/10148; G06T 2207/10016

(57) ABSTRACT

A system and respective method for use in assessment of call viability are described. The technique comprises: providing sample material cell cells within liquid carrier; applying physical stimulation to the sample material for generating flow within the sample material; directing coherent illumination onto the sample and collecting light portion interacting with said sample for generating a sequence of image data pieces associated with speckle patterns form in said light portion interacting with said sample; and processing said sequence of image data pieces for determining data indicative on cell viability in the sample.

### TECHNOLOGICAL FIELD

The present invention is in the field of in vitro cell inspection and is in particular relevant to assessment of call viability.

### BACKGROUND

Determining viability of cell cultures is a routine procedure in various research tasks. Generally, the target of cell viability assays is to provide data about the ability of biological cells to maintain and/or recover viability in terms of biological activity.

In general, data about viability of cells may be requires for various applications ranging between verifying condition of biological samples and drug production and testing.

### GENERAL DESCRIPTION

There is a need in the art for a novel system and technique enabling simple and direct assessment of viability of cell cultures. The present technique provides viability assessment utilizing optical inspection of samples, thus enabling efficient, fast and non-destructive viability data.

The present technique utilizes spatial analysis of secondary speckle patterns formed by light interaction (e.g. by scattering) with cells in a sample to be inspected. More specifically, light passing through the sample undergoes scattering from the cells in the sample. The scattering events introduce variations in phase and direction of light components that scatter from the cells. This in turn generates secondary speckle patterns in the light after passing through the sample. Motion of the cells in liquid carrier of the sample causes the speckle patterns to vary with time, causing spatial decorrelation between the speckle patterns over time.

Generally, due to random motion in the sample, correlation between the speckle patterns formed by light interaction with the sample decrease in time. Additional movement patterns, e.g. associated with biological activity, affects the statistical decay of speckle correlation enabling to obtain data on viability of the cells by variation from random Brownian motion.

Accordingly, the system and technique of the invention utilize capturing light patterns (forming secondary speckle patterns) transmitted through the sample by the sensor. The logic of capturing and analyzing such information is based on the notion that spatial-temporal changes occurring within the secondary speckle pattern are the result of alterations occurring within the media of the inspected tube.

To this end, the present technique enables determining an assessment of viability of calls, generally of cells present in liquid carrier, utilizing physical excitation of the cell to introduce certain motion pattern in the cell sample. Upon exciting the sample, the technique comprises transmitting coherent illumination onto the sample and collecting at least a portion of light after interacting with the sample, to generate a sequence of image data pieces associated with secondary speckle patterns formed in the collected light.

In additional configurations, the present technique utilizes defocused imaging of coherent illumination passing through the sample and determining correlation peaks between consecutive image data pieces collected during a measurement period. In these configurations, the location and size of the correlation peak provides data on viability of the cells in the sample.

Thus, according to one broad aspect, the present invention provides a method of use in assessment of call viability, the method comprising:

providing sample material cell cells within liquid carrier;

applying physical stimulation to the sample material for generating flow within the sample material;

directing coherent illumination onto the sample and collecting light portion interacting with said sample for generating a sequence of image data pieces associated with speckle patterns form in said light portion interacting with said sample; and

processing said sequence of image data pieces for determining data indicative on cell viability in the sample.

According to some embodiments, processing said sequence of image data pieces may comprise processing decorrelation time between said speckle patterns, wherein said decorrelation time being indicative of cell viability in the sample.

According to some embodiments, said collecting light portion interacting with said sample may comprise providing a detector array in optical path of light transmitted or reflected from said sample material to and operating said detector array for generating one or more sequences of image data pieces associated with speckle patterns in said light portion.

According to some embodiments, said determining an assessment of cell viability may comprise retrieving, from a database, one or more functions providing relation between correlation and cell viability. Said one or more functions may utilize one or more sample specific parameters in accordance with at least one of: length of optical path in the sample, optical density of sample carrier, cell type, cell concentration in the sample, wavelength of light, and orientation of the detection between transmission or reflection of light.

According to some embodiments, said processing said sequence of image data pieces may comprise determining correlation peak between consecutive image data pieces, location and magnitude of said correlation peak being indicative of cell viability in the sample.

According to some embodiments, said physical stimulation comprises rotating said sample for generating vorticity flow.

According to some embodiments, said physical stimulation comprises applying external stimulation field onto the sample. The external stimulation field may comprise at least one of ultrasonic stimulation, infrasonic stimulation, sonic stimulation, varying electrical field and varying magnetic field. Additionally or alternatively, the external stimulation field comprises optical stimulation field having wavelength and intensity selected for generating corresponding excitation of the sample. Such excitation of the sample may include optic-acoustic effect and/or excitation of phonons in the sample. More specifically the opto-acoustic effect is associated with external stimulation filed may utilizing one or more photonic pulses have selected wavelength and intensity for generating localized heat that forms corresponding one or more acoustic propagating signals. Alternatively, the optical stimulation field may comprise illumination with wavelength range selected for generating phonon in the sample in accordance with Brillouin coefficient of the sample (e.g. associated with lattice structure, or lattice-like structure as in water solution) such that the phonons form physical stimulation of the sample forming high frequency excitation.

According to one other broad aspect, the present invention provides a system for use in assessment of call viability, the system comprising a sample holder configured for supporting sample containing call in liquid carrier, illumination unit configured for directing coherent illumination of one or more wavelength ranges onto said sample, and collection unit comprising at lease a detector array and configured for collecting at least a portion of light interacting with said sample to thereby form at least one sequence of image data pieces comprising data on speckle patterns in said at least a portion of light, and a control unit configured for receiving input data associated with said at least one sequence of image data pieces, and for processing the input data for determining data on decorrelation rate of said speckle patterns, and for determining an assessment on viability of cells in said sample.

According to some embodiments, the sample holder may further comprise a stimulation unit configured for selectively applying mechanical stimulation to sample supported thereby.

According to some embodiments, the stimulation unit may be configured as a magnetic stirrer.

According to some embodiments, the sample holder may be a rotating or vibrating sample holder.

According to some embodiments, the sample holder may comprise a stimulation unit configured for applying at least one of ultrasonic stimulation, infrasonic stimulation, sonic stimulation, varying electrical field and varying magnetic field.

According to some embodiments, the collection unit may further comprise an optical arrangement position with respect to the detector array for generating focused image data indicative of an object plane located within the sample, said control unit comprises at least one processor adapted for determining data indicative of spatial decorrelation between speckle patterns collected by the collection unit within selected time of inspection.

According to some embodiments, the collection unit may further comprise an optical arrangement position with respect to the detector array for generating defocused image data indicative of an object plane located between the sample and the detector array, said control unit comprises at least one processor adapted for determining data indicative of magnitude and spatial shift in correlation peaks between image data pieces collected at different times during a measurement period to thereby determine on viability of the cells in the sample.

According to some embodiments, the control unit may further comprise a storage utility carrying pre-stored calibration data indicative of variation in flow decay rate with respect to viability levels of cells.

According to some embodiments, the control unit may be adapted for determining an assessment on viability of cells in the sample utilizing one or more sample specific parameters in accordance with at least one of length of optical path is the sample, optical density of sample carrier, cell type, cell concentration in sample, wavelength of light, and orientation of the detection between transmission or reflection of light.

According to yet another broad aspect, the present invention provides a system for use in assessment of call viability, comprising tube system and optical measurement system, said tube system comprising at least one pump configured for pumping liquid solution through said tube system and at least one measurement tube region having transparent walls; said optical measurement system comprising light source configured for emitting coherent optical illumination passing through said measurement tube region, and a collection unit located in optical path of light passing through said measurement tube region for collecting image data piece associated with speckle patterns formed in light passing through said measurement tube region.

According to some embodiments, the system may further comprise concentration detection unit configured for determining concentration of solution in said measurement tube region.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 shows a flow chart exemplifying a technique for viability assessment of cell culture according to some embodiments of the invention;

FIG. 2 shows a flow chart exemplifying processing actions associated with the technique for viability assessment of cell culture according to some embodiments of the invention;

FIG. 3 illustrates a system for optical assessment of viability of cell according to some embodiments of the invention;

FIG. 4 shows experimental results of cell viability with respect to decorrelation parameter showing efficiency of the present technique; and

FIG. 5 schematically illustrates a system for optical assessment of cell viability according to some embodiments of the invention.

### DETAILED DESCRIPTION OF EMBODIMENTS

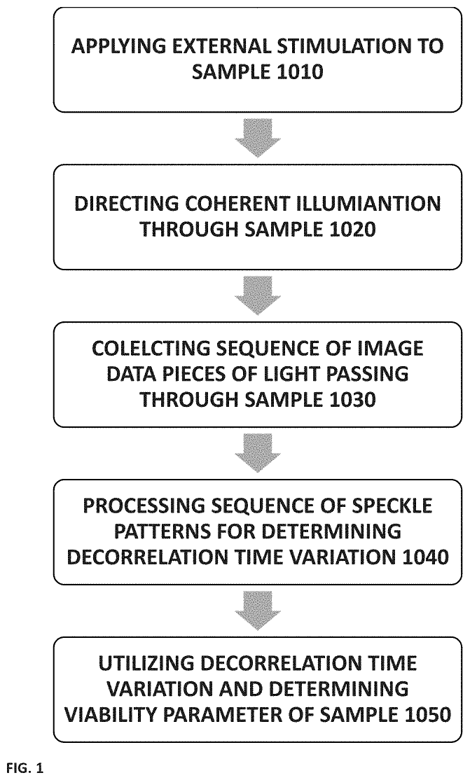

As indicated above, the present technique provides a system and method enabling inspection of cell samples for determining viability assessment of the cells. Reference is made to FIG. 1 illustrating in a way of a flow chart, main elements of the present technique.

As indicated above, the present technique is based on determining data associated with flow statistics of an inspected sample. The flow parameters may be determined in accordance with decay in spatial correlation between speckle patterns formed by light passing through the sample and collected by an imaging unit. Accordingly, the technique utilizes applying an external stimulation to the sample 1010 to initiate flow in the sample and enable optical inspection of the sample. The external stimulation may generally be associated with stirring of the sample for a selected period, to introduce certain vorticity flow. For example, the external stimulation may be applied manually or utilizing one or more automated stirring techniques. Such automated stirring mechanism may be embedded into the monitoring system or not. In some configuration, selection of duration of the stimulation may be associated with cell concentration, optical density and/or viscosity of the sample.

After stimulating the sample, the sample may be placed on a selected sample mount for inspection, preferably while maintaining stimulated vorticity flow in the sample. The inspection includes illuminating the sample by coherent illumination 1020, for example, by directing coherent light beam to pass through the sample. The illumination is generally selected in wavelength range that is at least partially transmitted through the sample, while provided certain scattering. The illumination is directed toward the sample by passing light beam through at least a portion of the sample. Light components passing through the sample interact with the material of the sample, e.g. by scattering from cells and other scatterers in the sample. This scattering results in self-interference between light components, forming secondary speckle patterns in the light transmitted through the sample. Collecting light transmitted through the sample 1030 and generating of corresponding image data pieces, provides sequence of image data pieces capturing speckle patterns of the so-generated secondary speckles. Collection of the light transmitted through the sample may be done by focusing imaging unit (e.g. camera) onto certain plane within the sample (defined by the sample holder location) to provided focused imaging of the sample or by focusing the imaging unit onto an arbitrary plane between the sample and the imaging unit, i.e. defocused imaging. The use of focused imaging may be used for determining viability by determining decorrelation of speckle pattern over time. In some configuration using defocused imaging, location and size of correlation peak are determined for assessing viability of the cells. It should be noted that the differences between focused imaging and defocused imaging in the context of the present technique is associated with the inventors understanding that certain behavior of the so-generated speckle patterns is more visible in focused or defocused imaging. The coherent light beam is typically transmitted through the sample forming speckle patterns therein. However, correlation peak location is generally better observed using defocused imaging, which increases the speckle pattern over any other image of the sample that might be collected. This is while focused imaging provides indication on scatterers movement in the flow and thus yields better results for determining decorrelation of the speckle patterns.

For efficient sampling, the present technique utilizes collecting of one or more sequences image data pieces 1030 at sampling rate that is sufficient for characterizing decay of the vorticity flow in the sample. The collected image data pieces generally include images associated with speckle patterns formed in the light passing through the sample enabling the present technique to determine correlation scores between the image data pieces. Due to the flow in the sample, the correlation scores between image data pieces decrease indicating decorrelation between speckle patterns associated with decorrelation between distribution of scatterers and cells in the sample. The present technique utilizes processing of the collected image data pieces 1040 for determining a rate of decorrelation between the collected speckle patterns. The processing includes determining levels of correlations between speckle patterns collected at various times along the sampling period with respect to one or more speckle patterns collected at early stages of the sampling period to determine decorrelation of the speckle patterns. The decorrelation, or decay of correlation, between the speckle patterns provides statistical data about flow within the sample. The inventors have found that such indication on flow decay provides data enabling to assess viability of cells in the sample 1050 in accordance with characteristic decorrelation time. The assessment of viability may typically be determined in accordance with pre-stored data on viability, taking into account one or more sample parameters such as optical path of light passing through the sample, optical density of the sample, cell type etc.

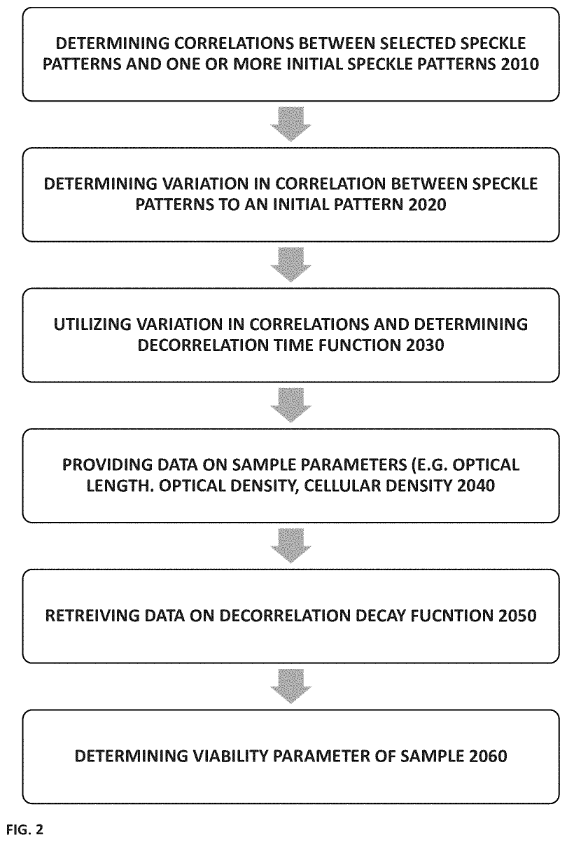

The processing of the collected image data pieces according to some embodiments of the present technique is further illustrated as flow chart in FIG. 2. The processing operations indicated in FIG. 2 are generally associated with elements 1040 and 1050 of FIG. 1 describing determining decorrelation and corresponding viability assessment according to some embodiments of the invention. As shown, the processing in this example may include selecting one or more initial speckle patterns, associated with image data pieces collected at early stages of the monitoring such as the first frame of monitoring, and determining correlation scores between selected speckle patterns collected in different time of monitoring and the initially selected speckle patterns 2010. The correlation scores typically relate to a measure of how much the speckle patterns have changed between the selected initial pattern and the selected patterns collected at time t of monitoring. Determining the variation in correlation scores between the speckle patterns over time 2020, enables to determine one or more decorrelation time functions 2030 indicating the decrease in correlation score with time. This decrease in correlation score is typically natural and caused by the flow of material in the sample as well as by Brownian motion within the sample. The decorrelation time functions are used in combination with additional data on the sample for determining the viability assessment based on statistical analysis, e.g. as compare to decorrelation in non-viable sample. To this end, the technique utilizes providing one or more parameters of the sample 2040 to provide reference for statistical analysis of decorrelation time. The sample parameters may be provided by retrieving the data from a storage device, providing the data by manual input by an operator or any other technique. The sample parameters may typically include data on length of optical path within the sample, optical density of the sample, cellular concentration, etc. These parameters may generally be stored as is in a storage device or be associated with various functions indicating rate of decorrelation and stored accordingly for use for providing accurate assessment with reduced processing. Further, pre-stored data, e.g. lookup table or decay parameters, indicative of statistical behavior of decorrelation rates may be retrieved from a storage module 2050. Thus, provided the decorrelation time function, sample parameters and data of correlation decay, the technique is used for determining an assessment on viability parameters of the sample 2060. In this connection, the differences between solutions containing cells of different viability levels may be identified by analyzing statistical characteristics of decay in correlation of speckle patterns. Such differences can be used to provide lookup table for determining viability of an unknown sample.

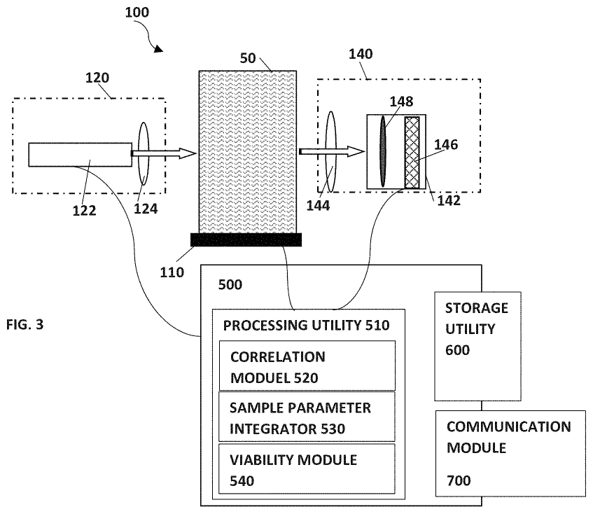

As indicated above, transmission of coherent illumination through the sample, and collection of images formed by the transmitted light and associated with speckle patterns formed by light passing through the sample, provides image data pieces including speckle patterns formed by self-interference of light components. This is due to partial scattering of light components, e.g. from call in the sample. Reference is made to FIG. 3 schematically illustrating a system 100 configured according to some embodiments of the invention for determining an assessment of viability of cell sample/culture.

The system 100 includes an illumination unit 120, a collection unit 140 and a control unit 500, and typically may also include, or be associated with, a sample holder 110. The illumination unit 120 includes at least one light source 122 and is configured for providing coherent illumination of one or more wavelength ranges transmitted toward a sample 50. In the example of FIG. 3, the illumination unit 120 includes a light source 122 being a laser unit and an attenuator 124 located in optical path of light emitted from the light source and configured for reducing intensity of light to avoid saturation of the detector and/or any possible nonlinearity in the system. In some configurations the illumination unit may also include one or more optical elements such as one or more lenses and a polarization filter that are not specifically shown herein. Generally, the use of one or more lenses may provide focusing of light beam emitted by the light source 122 to a focal plane located within the sample 50 (generally at a selected plane defined by location of the sample holder 110). A polarization filter may be used to provide selected linear or circular polarization of light, combined with corresponding polarization filter at the collection unit 140 for improving signal to noise, e.g. by collection of scattered light components using orthogonal polarization filtering at the collection unit.

The collection unit 140 includes an imaging unit 142 formed by a detector array 146 and an optical arrangement 148. The optical arrangement 148 and the detector array 146 are preferably arranged, in terms of relative position and optical power, for collecting images associated with speckle patterns formed by self-interference of light components passing through the sample 50. More specifically, as indicated above, the optical arrangement 146 and detector array 148 may be arranged to provide focused or defocused imaging with respect to a selected plane within the sample 50. Accordingly, the relative distance between the optical arrangement 148 and the detector array 146 provides 1/f=1/U+1/V where f is effective focal length of the optical arrangement 148, U is the distance between an object plane and V is the distance between the optical arrangement 146 and the detector array 148. Thus, the optical plane may be located within the sample 50 to provide focused imaging, or it may be located at a selected plane between the sample and the optical arrangement 148 to provide defocused imaging. As indicated above, the selection between focused and defocused imaging is preferably accompanied with corresponding correlation processing.

Further, in this example the collection unit 140 may also include a polarization filter 144 (generally linear polarization filter) used for increasing signal to noise ratio of light collection. This polarization filter may be used with or without the use of polarization filter at the illumination unit 120 as indicated above.

As indicated above, to provide certain flow in the sample 50 prior to monitoring flow decay rate in the sample, the sample may preferably be physically stimulated, e.g. by generating vortex flow by circulating or stirring the sample 50. While allowing flow resulting of the stimulation to decay, the illumination unit 120 is configured for transmitting a beam of coherent illumination of one or more wavelength ranges toward the sample 50, typically located on the sample holder 110. The collection unit 140 is positioned and configured for collecting light components of the beam transmitted through the sample 50 and for generating one or more sequences of image data pieces. The image data pieces contain images including secondary speckle patterns generated by self-interference of light components that undergo scattering from particles and cells in the sample 50. The collection unit 140 is generally operates at a selected sampling rate, sufficient for sampling decay in the flow of the sample. Generally, the collection unit may operate at a sampling rate of e.g. 20-60 fps, under an assumption that the flow decay is at least a few seconds long.

In some configurations, the sample holder 110 may be configured for applying the selected stimulation of the sample. For example, the sample holder 110 may include a magnetic stirring mechanism or be rotatable or vibrating sample holder 110. In some further embodiments, the sample holder may include selected stimulation unit configured for applying at least one of ultrasonic stimulation, infrasonic stimulation, sonic stimulation, varying electrical field and varying magnetic field as well as optical stimulation selected for generating corresponding acoustic or signal by opto-acoustic effect or for exciting phonons within Brillouin boundaries of the sample. This omits the need to move the sample between stimulation and inspection of viability. Additionally or alternatively, the sample holder may include heating or cooling elements (e.g. heating coil, cold finger contact etc.) and configured to maintain a selected constant temperature of the sample 50. For example, the sample holder 110 may be configured to maintain sample temperature around 36-40 degrees for providing suitable conditions for selected cells. In some configurations, temperature of the sample holder 110 may be selected in accordance with optimal conditions for selected cells to be inspected and type of inspection.

The collection unit 140 is further adapted for transmitting data on the collected image data pieces to the control unit 500, which operates for processing the collected data in accordance with the above described technique for determining an assessment on viability of cells in the sample. The control unit 500 generally includes a processing utility 510 including one or more processors, storage utility 600 and input/output communication module (not specifically shown). The control unit may also include a communication module 700 such as network communication module and/or user interface for receiving and transmitting operation data and assessment results. The processing 510 utility adapted for utilizing the above described technique for determining an assessment of cell viability in accordance with input data in the form of one or more sequences of image data pieces including speckle patterns formed by light transmission through the sample, and in some configuration using reference data provided as user input and/or pre-stored in the storage utility 600.

The control unit 500 may also be connectable to the illumination unit 120 and/or sample holder 110 for providing operations command thereto. Such commands may be associated with variation of illumination patterns, e.g. continuous wave of pulsed illumination, wavelength selection, temperature of the sample, etc.

Additionally, the control unit 500 is configured and operable for receiving input data formed by one or more sequences of image data pieces collected by the detector array 146, and for processing the input data for determining estimation on viability of cells in the inspected sample 50. To this end, the processing utility 510 may include software or hardware modules, including for example correlation module 520, sample parameter integrator 530 and viability module 540. The correlation module 520 is configured for determining correlations between consecutive speckle patterns and time-correlation function in accordance with the sequence of image data pieces received from the detector array 146, for determining correlation decay time. The sample parameter integrator 530 is configured for retrieving data about parameters of the sample as described with reference to action 2060 in FIG. 2 for integrating measurement data with statistical data on decay of correlation. The viability module 540 utilizes statistics of correlation decay and sample/measurement parameters for determining an estimation on viability of cell in the sample and operates the processing utility 510 for generating corresponding output data.

The present technique has been subject of experimental study using culture of Jurkat cells a dedicated media. The culture was grown to a concentration of ˜1.5-3.5×10\hat{ }6 cells/ml using internal protocols. The cultured solution was centrifuged to separate the cultured cells from their media and divided into aliquots. The cells were re-suspended with fresh media after removal of the supernatant to minimize bias associated with variations between the cultured solutions. The cell concentrations and viabilities were assessed using automated cell counter and using hemocytometer approaches. Additional aliquots of the cultured solutions were prepared by transferring 2 ml of the stock solution into transparent Eppendorf tubes. To minimize temperature gradients and thermal interruptions, the air-conditioning was turned off prior to inspection of the samples. The heating plate, used as sample mount, was set 37° C., and actual temperature was verified via a laser infrared thermometer.

An inspected tube was placed in the heating plate for a period of 5 minutes, moved to be mixed by vortexing to introduce initial flow within the tube, and immediately placed back into the heating plate for a period of 30 seconds to minimize bias associated with temperature gradients formed during vortexing. The sample was inspected by collecting image data pieces for 10 seconds for determining Tau DC values associated with decay of correlations between speckle patterns in the image data pieces. For comparative analysis and validating the assessment of viability provided by the present technique three different comparative evaluations were performed:
1) Old media (including high viability culture) vs. fresh media with cultures of various viability levels.
2) ≥88% viability vs. 50% viability, at a concentration of ˜3.25 cells/ml.
3) ≥80% viability vs. 30% viability, at a concentration of ˜1.84 cells/ml.

Table 1 shows results of the decorrelation parameter Tau DC as a function of cell concentration and viability in the different samples.

TABLE 1

| Tube | Repeat | | Cell | Tau DC | | |
|---|---|---|---|---|---|---|
| # | # | Cells/ml | Viability | Value | Mean | STD |
| 1 | a | 3.18*10\hat{ }6 | 97% | 1.5 | 1.47 | 0.35 |
| 1 | b | 3.18*10\hat{ }6 | 97% | 1.1 | | |
| 1 | c | 3.18*10\hat{ }6 | 97% | 1.8 | | |
| 2 | a | 3.3*10\hat{ }6 | 94% | 1.7 | 1.70 | 0.20 |
| 2 | b | 3.3*10\hat{ }6 | 94% | 1.5 | | |
| 2 | c | 3.3*10\hat{ }6 | 94% | 1.9 | | |
| 4 | a | 3.2*10\hat{ }6 | 88% | 1.4 | 1.63 | 0.21 |
| 4 | b | 3.2*10\hat{ }6 | 88% | 1.8 | | |
| 4 | c | 3.2*10\hat{ }6 | 88% | 1.7 | | |
| 3 | a | 3.3*10\hat{ }6 | 50% | 2.5 | 2.27 | 0.25 |
| 3 | b | 3.3*10\hat{ }6 | 50% | 2.3 | | |
| 3 | c | 3.3*10\hat{ }6 | 50% | 2 | | |
| 5 | a | 3.2*10\hat{ }6 | 50% | 2.6 | 2.43 | 0.21 |
| 5 | b | 3.2*10\hat{ }6 | 50% | 2.2 | | |
| 5 | c | 3.2*10\hat{ }6 | 50% | 2.5 | | |
| 5 | a | 3.2*10\hat{ }6 | 50% | 2.1 | 2.33 | 0.25 |
| 5 | b | 3.2*10\hat{ }6 | 50% | 2.3 | | |
| 5 | c | 3.2*10\hat{ }6 | 50% | 2.6 | | |
| 6 | a | 1.88*10\hat{ }6 | 88% | 2.4 | 2.40 | 0.00 |
| 7 | b | 1.88*10\hat{ }6 | 88% | 2.4 | | |
| 8 | a | 1.88*10\hat{ }6 | 80% | 2.6 | 2.60 | |
| 9 | a | 1.8*10\hat{ }6 | 30% | 3.5 | 3.30 | 0.17 |
| 9 | b | 1.8*10\hat{ }6 | 30% | 3.2 | | |
| 9 | c | 1.8*10\hat{ }6 | 30% | 3.2 | | |

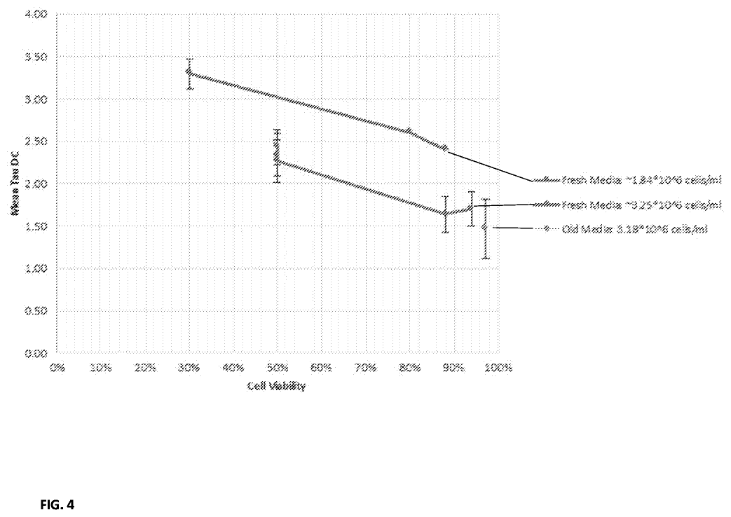

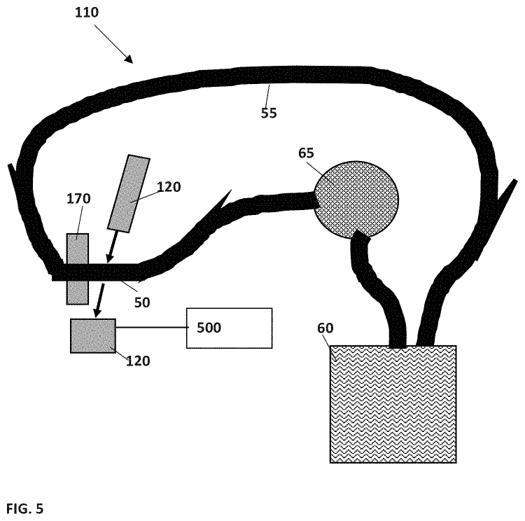

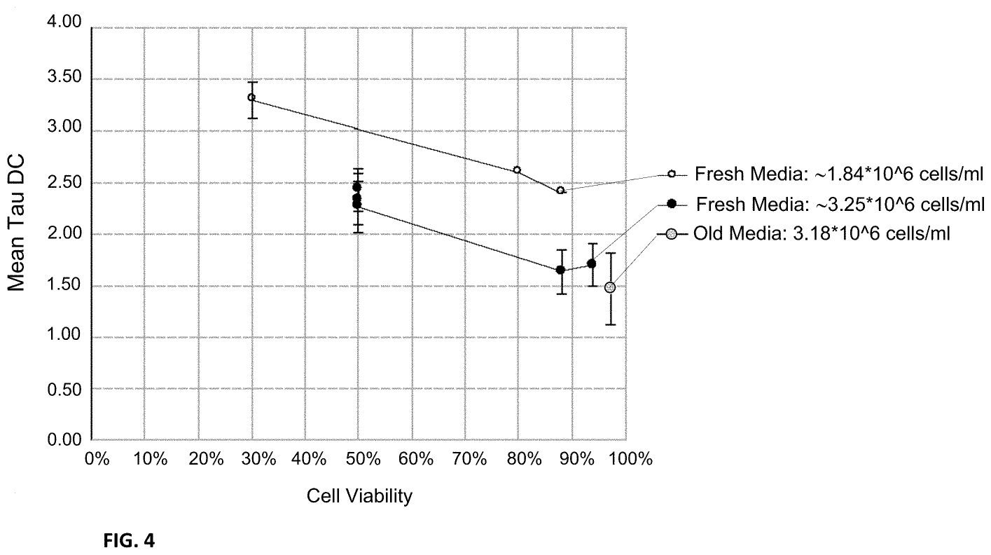

Reference is made to FIG. 4 showing the results of table 1 graphically, illustrating relation between cell viability and measured decorrelation parameter. The graph includes three data series named: fresh media: ˜1.84*10\hat{ }6 cell/ml, fresh media; ˜3.25*10\hat{ }6 cell/ml, and Old media: 3.18*10\hat{ }6 cell/ml. although referred to as old media the tube number 1 includes the highest viability cell sample as indicated in table 1. As shown, there is linear (negative) relation between cell viability and the decorrelation parameter, where the linear coefficients depend of sample parameters such as concentration of the sample, and typically cell types. Further, the assessment technique validates the “old media” reference sample, where viability of the cells is 97% as having high viability.

These experimental results clearly illustrate relation between decorrelation of speckle patterns and viability of cells in a sample. This enables the present technique to distinguish between different levels of cell viabilities at a selected cellular concentration. The present technique is thus capable of assessing vibrant properties of an inspected sample in a remote and contactless matter, and generally not affecting the sample. Thus, the present technique provides a system and a corresponding method for optical assessment of cell viability.

Reference is made to FIG. 5 schematically illustrating an additional configuration of system for determining cell viability data according to the present technique. In this configuration, liquid solution including cell cultures is locating in a container 60 and being pumped using pump 65 through tube system 55. The tube system includes at least one straight region having transparent walls 50. Tube region 50 may also be configured as having rectangular or square cross-section to reduce light refraction effects. The system 110 also includes a light source unit 120 and collection unit 140 as described in FIG. 3 and includes or is associated with control unit 500. Generally, system 110 may also include a cell concentration monitoring unit 170, configured for measuring and determining concentration of cells in the solution within pipe region 50.

For measurement of cell viability, the pump 65 is operated for a selected period, to push solution through the pipes system 55 and provide physical stimulation (e.g. pressure waves) to the calls in the solution. After the selected period, the pump stops its operation and the call containing solution located in pipe region 50 is measured as described above.

Generally, the solution is maintained in chamber 60, and through the pipe system 65, in selected temperature conditions optimal for the cell type being measured. For example, the solution may be kept at temperature between 35-40 degrees Celsius. This configuration enables assessment of cell viability while reducing the need for contact with the cell solution, and/or transferring the cell solution between containers, which may cause various interfering effects and introduce contaminations to the solution.

The cell concentration monitoring unit 170 may typically include a laser light source and two optical sensors. The laser light source is configured to emit light beam of selected wavelength range being at least partially absorbed by the cells in the solution. The light beam is split into two separate beams using a beam splitter, where which one beam is directed to pass through the optical path of the inspected pipe region 50 containing the sampled solution (“signal path”), and the other, is directed to pass through water bath (“reference path”) providing substantially similar optical path. Signal sensor and reference sensor are respectively positioned for collecting the light beams after passing through the sample and reference bath enabling to determine relative concentration of the cell in the solution.

This exemplary configuration enables monitoring cell viability at large quantities, or in continuous fashion, while maintaining selected (optimal) conditions for the call culture. This configuration further enables monitoring of call concentration and stimulation strength. Thus, the present technique provides system and method for determining cell viability data as described herein.

1. A method of use in assessment of call viability, the method comprising:
providing sample material cell cells within liquid carrier,
applying physical stimulation to the sample material for generating flow within the sample material;
directing coherent illumination onto the sample and collecting light portion interacting with said sample for generating a sequence of image data pieces associated with speckle patterns form in said light portion interacting with said sample; and
processing said sequence of image data pieces for determining data indicative on cell viability in the sample.

2. The method of claim 1, wherein said processing said sequence of image data pieces comprises processing decorrelation time between said speckle patterns, wherein said decorrelation time being indicative of cell viability in the sample.

3. The method of claim 2, wherein said collecting light portion interacting with said sample comprises: providing a detector array in optical path of light transmitted or reflected from said sample material to and operating said detector array for generating one or more sequences of image data pieces associated with speckle patterns in said light portion.

4. The method of claim 2, wherein said determining an assessment of cell viability comprising retrieving, from a database, one or more functions providing relation between correlation and cell viability.

5. The method of claim 4, wherein said one or more functions utilize one or more sample specific parameters in accordance with at least one of length of optical path is the sample, optical density of sample carrier, cell type, cell concentration in sample, wavelength of light, and orientation of the detection between transmission or reflection of light.

6. The method of claim 1, wherein said processing said sequence of image data pieces comprises determining correlation peak between consecutive image data pieces, location and magnitude of said correlation peak being indicative of cell viability in the sample.

7. The method of claim 1, wherein said physical stimulation comprises rotating said sample for generating vorticity flow.

8. The method of claim 1, wherein said physical stimulation comprises applying external stimulation field onto the sample.

9. The method of claim 8, wherein said external stimulation field comprises at least one of ultrasonic stimulation, infrasonic stimulation, sonic stimulation, varying electrical field and varying magnetic field.

10. The method of claim 8, wherein said external stimulation field comprises optical stimulation field having wavelength and intensity selected for generating corresponding acoustic signals associated with opto-acoustic effect.

11. The method of claim 8, wherein said external stimulation field comprises optical stimulation field having wavelength range selected in accordance with lattice structure of the sample to thereby excite high frequency vibrations within the sample.

12. A system for use in assessment of call viability, the system comprising a sample holder configured for supporting sample containing call in liquid carrier, illumination unit configured for directing coherent illumination of one or more wavelength ranges onto said sample, and collection unit comprising at lease a detector array and configured for collecting at least a portion of light interacting with said sample to thereby form at least one sequence of image data pieces comprising data on speckle patterns in said at least a portion of light, and a control unit configured for receiving input data associated with said at least one sequence of image data pieces, and for processing the input data for determining data on decorrelation rate of said speckle patterns, and for determining an assessment on viability of cells in said sample.

13. The system of claim 12, wherein said sample holder further comprise a stimulation unit configured for selectively applying mechanical stimulation to sample supported thereby.

14. The system of claim 13, wherein said stimulation unit is configured as a magnetic stirrer.

15. The system of claim 13, wherein said sample holder is a rotating or vibrating sample holder.

16. The system of claim 13, wherein said sample holder comprises a stimulation unit configured for applying at least one of ultrasonic stimulation, infrasonic stimulation, sonic stimulation, varying electrical field and varying magnetic field.

17. The system of claim 12, wherein said collection unit further comprises an optical arrangement position with respect to the detector array for generating focused image data indicative of an object plane located within the sample, said control unit comprises at least one processor adapted for determining data indicative of spatial decorrelation between speckle patterns collected by the collection unit within selected time of inspection.

18. The system of claim 12, wherein said collection unit further comprises an optical arrangement position with respect to the detector array for generating defocused image data indicative of an object plane located between the sample and the detector array, said control unit comprises at least one processor adapted for determining data indicative of magnitude and spatial shift in correlation peaks between image data pieces collected at different times during a measurement period to thereby determine on viability of the cells in the sample.

19. The system of claim 12, wherein said control unit further comprises a storage utility carrying pre-stored calibration data indicative of variation in flow decay rate with respect to viability levels of cells.

20. The system of claim 12, wherein said control unit is adapted for determining an assessment on viability of cells in the sample utilizing one or more sample specific parameters in accordance with at least one of length of optical path is the sample, optical density of sample carrier, cell type, cell concentration in sample, wavelength of light, and orientation of the detection between transmission or reflection of light.

21. A system for use in assessment of call viability, comprising tube system and optical measurement system, said tube system comprising at least one pump configured for pumping liquid solution through said tube system and at least one measurement tube region having transparent walls; said optical measurement system comprising light source configured for emitting coherent optical illumination passing through said measurement tube region, and a collection unit located in optical path of light passing through said measurement tube region for collecting image data piece associated with speckle patterns formed in light passing through said measurement tube region.

22. The system of claim 21, further comprising concentration detection unit configured for determining concentration of solution in said measurement tube region.
